(19) United States
(12) Patent Application Publication
(10) Pub. No.: US 2004/0127261 A1
(43) Pub. Date: Jul. 1, 2004

(54) Method and monitoring means for monitoring the performance of an antenna device

(75) Inventor: Friedrich Endress, Renningen (DE)

Correspondence Address: SUGHRUE MION, PLLC, 2100 PENNSYLVANIA AVENUE, N.W., SUITE 800, WASHINGTON, DC, 20037, US

(73) Assignee: EVOLIUM S.A.S.

(21) Appl. No.: 10/728,918

(22) Filed: Dec. 8, 2003

(30) Foreign Application Priority Data
Dec. 30, 2002 (EP) 02 360 379.8

(51) Int. Cl. H04M 1/00

(52) U.S. Cl. 455/562.1

(57) ABSTRACT

The invention relates to a method and monitoring means for monitoring the performance of an antenna device. In the prior art the monitoring of the performance of antenna systems, in particular of antenna systems of base stations, has been done by monitoring systems comparing actually measured performance samples with common and fixed alarm threshold values which shall be valid for many antenna systems but which were not adapted to individual antenna device installations. In order to achieve more reliable alarms with less costs the present invention proposes to detect a deterioration in the performance of the antenna device by watching and evaluating the variation of different performance samples taken from time to time from said antenna device.

### TECHNICAL FIELD

The invention relates to a method and a monitoring means for monitoring the performance of an antenna device. Further, the invention relates to a radio base station comprising such a monitoring means and a mobile radio system comprising such radio base stations. The invention is based on a priority application EP 02 360 379.8 which is hereby incorporated by reference.

### BACKGROUND OF THE INVENTION

From the U.S. Pat. No. 6,266,528 B1 a performance monitor for antenna arrays is known. According to that patent in cellular telephone base station applications for a base station using an array of antenna elements to obtain spatial diversity samples of the received signal strength are taken during particular times whenever an active mobile subscriber is operating in the area. Periodically, such samples are averaged and added to a running total that is maintained in a long-term accumulator for each antenna. The accumulated totals are then compared and averaged after a statistically sufficient number of samples has been collected. Faulty antennas, including broken ones and ones with bad connections, will be revealed by those corresponding signal paths having relatively low accumulated totals.

Further, in the prior art supervision of antenna systems like base station antennas for mobile communication systems normally is done by monitoring systems working with fixed alarm levels. These fixed alarm levels are either calculated individually for each antenna system by using parameters like “feeder cable loss”, etc. or more typically, these predetermined alarm levels are common and fixed for whole networks comprising many antenna systems. The parameter(s) to be supervised and for which such predetermined and fixed alarm levels are computed might be the Voltage Wave Standing Ratio (VSWR) for antenna systems including transmit signals and/or the received signal strength or other receive quality parameters for antenna systems including receive signals.

However, the use of such a common and fixed alarm threshold value for different antenna systems has the disadvantage that it does neither consider tolerances of the monitoring system nor of the individual antenna system installations. Consequently, the used alarm thresholds are not individually adapted to the antenna systems; either the alarm threshold value is set aggressive with the risk of fault alarms or the alarm threshold value is set intensive and even a broken antenna might not generate an alarm. Consequently, with the use of fixed alarm threshold values for different antenna systems it is hardly not possible to generate reliable alarms with respect to the performance of an individual antenna system.

### SUMMARY OF THE INVENTION

Starting from that prior art it is the object of the present invention to improve a known method and monitoring means for monitoring the performance of an antenna device as well as a radio base station comprising such a monitoring means as well as a mobile radio system comprising such a mobile station such that more reliable alarms for individual antenna devices can be generated. That object is solved by the method for monitoring the performance of an antenna device comprising the steps of: measuring from time to time the performance of the antenna device for achieving performance samples with 1≦i≦n, whereby watching the variation of said performance samples over the time; and detecting a deterioration in the performance of the antenna device depending on the amount of said variation. More specifically, this object is achieved by watching the variation of the performance of samples pᵢ over the time and detecting a deterioration in the performance of the antenna device depending on the amount of said variation.

Contrary to the prior art according to the present invention a deterioration of the performance of an antenna device is not detected by comparing performance samples with a predetermined fixed or externally given predetermined threshold value but the performance samples are compared with each other, i.e. not an absolute but a relative comparison or measurement method is proposed. Expressed in other words, an initially or previously taken performance sample represents a threshold value or reference value for determining the variation in comparison to later taken performance samples.

The claimed method has the advantage that it is adapted to the individual antenna installations the performance of which shall be determined; thus, more reliable alarms are possible. Moreover, contrary to the prior art of an absolute measurement here no expensive measuring devices are required; thus the proposed method is cheaper than methods used in the prior art.

According to a preferred embodiment of the claimed method recently occurred deteriorations may be detected by comparing a newly or last taken performance sample with a previously taken performance sample. If the difference between said two performance samples is high, a quick repair of the deterioration may be started.

According to a second embodiment of the claimed method a deterioration of the performance of an antenna device which may have been caused some time ago may be detected by comparing the newly or last taken performance sample with an initially taken performance sample. In that case a second alarm signal representing a gradual change in the performance may be generated.

Of course, according to the invention arbitrary pairs of performance samples, having an arbitrary long time interval in between may be compared with each other to check the performance.

Further advantageous embodiments of the application are subject-matters of the dependent claims.

The above-identified object of the invention is further solved by a monitoring means for carrying out the claimed method, a radio base station comprising such a monitoring means and a mobile radio system comprising such radio base stations. The advantages of said solutions correspond to the advantages mentioned above by referring to the claimed method.

### BRIEF DESCRIPTION OF THE DRAWINGS

Hereinafter several embodiments of the invention are described in detail by referring to the figures accompanying the description wherein

FIG. 1 shows a radio base station comprising a monitoring means according to the invention;

FIG. 2 shows a flow chart illustrating the method according to the invention; and

FIG. 3 showing a mobile base station according to the invention.

### DETAILED DESCRIPTION OF PREFERRED EMBODIMENTS

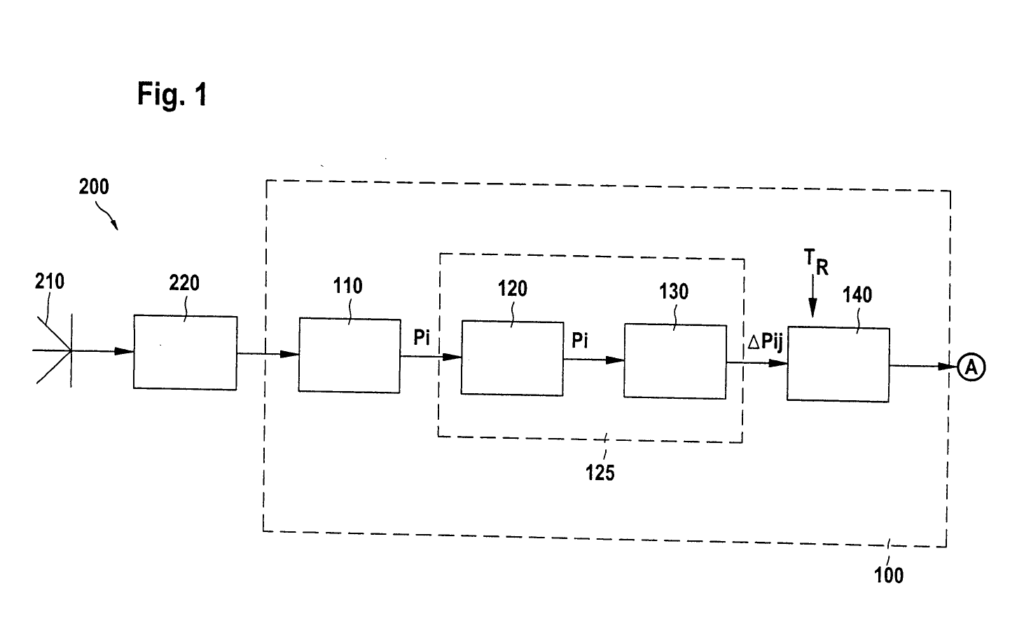

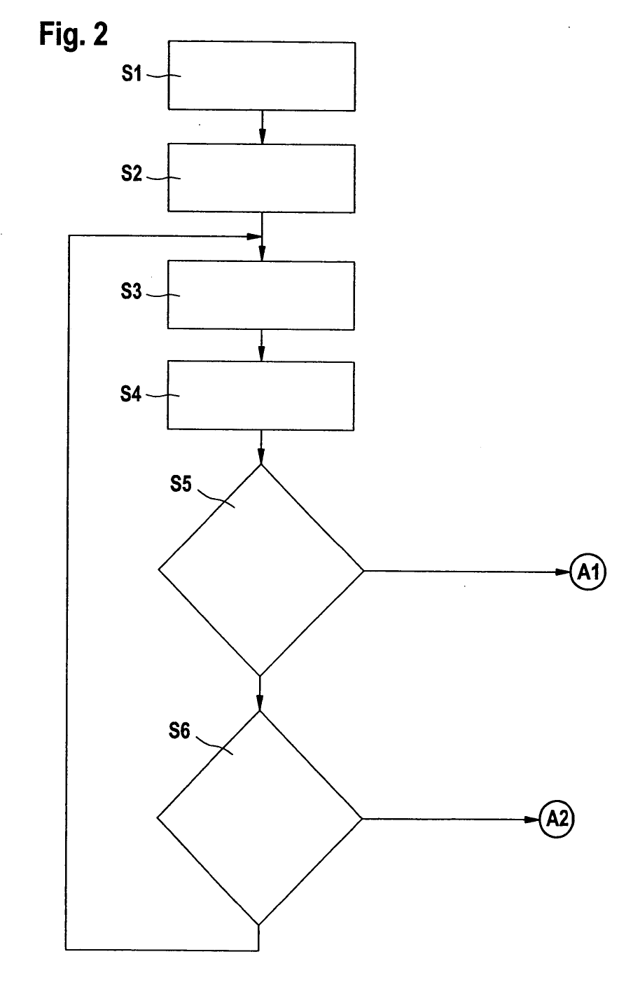

In the following the construction and operation of a monitoring means shall be explained by referring to FIGS. 1 and 2.

In FIG. 1 a radio base station 200 according to the invention is shown. It comprises an antenna device 210 and a transmitter, receiver or transceiver device 220 for transmitting and/or receiving signals over the antenna device 210. For monitoring the performance of the antenna device 210 the signals and/or parameters to be supervised and related to the performance of said antenna device 210 are extracted by the device 220 and input into a monitoring means 100. Said monitoring means 100 comprises a measuring means 110 for measuring from time to time the performance of the received antenna signals by taking performance samples pᵢ with 1≦i≦n with i representing discrete times. Each performance sample pi is obtained by averaging the supervised signal(s) and/or parameter(s) within the observation time of performance sample pi.

According to FIG. 2 the claimed method proposes in a first measurement step S1 to carry out an initializing method step for achieving a first performance sample p₁. It is assumed that at the beginning the antenna device is checked and that thus the measured performance sample p₁ can be taken as an initializing performance sample representing a properly operating antenna device. Alternatively, a proper initializing performance sample p₁ may be generated by carrying out an external measurement of the antenna system performance.

In a second method step S2 said initial performance sample p₁ which is not a general value but which has been individually generated with respect to the antenna device the performance of which shall be determined is stored in a storage means 120. For transmitting antenna devices the initial performance sample might be generated, e.g. by using the Voltage Standing Wave Ratio VSWR parameter, whereas for receiving antenna devices said samples might be generated by using e.g. the received signal strength indication RSSI-parameter.

In a third step S3 another performance sample pᵢ is achieved by carrying out a further measurement at a time i by the measuring unit 110. According to method step S4 in FIG. 2 said newly generated performance sample pᵢ is also stored within said storage means 120. Method steps S3 and S4 may be repeated for an arbitrary number of times before actually starting a monitoring of the performance of the antenna device 210 by going to method step 5. According to method step 5 a newly or last measured performance sample pₙ is compared with a previous performance sample Pₙ₋₁ and the difference between said two performance samples is calculated. The amount of said difference represents the variation of the performance samples over the time.

According to a first embodiment of the invention as shown in FIG. 1 said calculation is done by a calculating means 130 preferably accompanied within said monitoring means 100. The combination of said storage means 120 and of said calculating means 130 may also be referred to as watching means 125 because it serves for watching the variation of said performance samples pᵢ over the time.

Within step S5 the amount of the difference between the previous performance sample pₙ₋₁ and the last or new performance sample pₙ is compared to a first threshold value T_{R1} for detecting an eventual deterioration in the performance of the antenna device 210. More specifically, such a deterioration is detected by the detecting means 140 in the case that the difference/variance between the two compared performance samples Pₙ₋₁, Pₙ exceeds said first threshold value T_{R1}. Theoretically, said first threshold value T_{R1} might be set to 0 but in practice certain tolerances must be accepted so that the first threshold value T_{R1} is not set to 0 but to another acceptable value. In the case that the variation is greater than said first threshold value preferably a first type of alarm A1 is generated. Due to the specific compared performance samples Pₙ₋₁ and pₙ said first alarm type provides the information that a deterioration of the performance of the antenna has just recently occurred within the time interval tₙ₋₁ to tₙ.

Of course, the described comparison must not necessarily be carried out between two adjacent performance samples like pₙ₋₁ and Pₙ₋₁ but may also be carried out between two performance samples having another arbitrary time interval therebetween.

An example for such a measurement is given and carried out in method step 6 according to FIG. 2. In that step preferably a last performance sample pₙ is compared with the first or initial performance sample p₁. There is the time interval tₙ-t₁ therebetween. Consequently, if the difference between said performance samples Pₙ and p₁ exceeds a second threshold value T_{R2} also a deterioration in the performance of the antenna device 210 is detected. Consequently, in difference to the detection done in method step S5 the detection in method step S6 only leads to the result that the detected deterioration of the antenna device 210 must have been occurred within the longer time interval tₙ-t₁. Thus, a second type of alarm A2 representing a gradual change in the deterioration may be generated.

According to FIG. 2 method step S6 is carried out if method step S5 does not lead to a detection of a deterioration. In the case that also method step 6 does also not lead to a detection of a deterioration it is proposed to go back to the beginning of method step 3 for generating new performance samples Pₙ₊₁ . . . .

The amount of the difference that means the amount the variation between the two compared performance samples represents the amount of the deterioration. Thus, small variations only represent little deteriorations and in these cases only a warning may be sufficient for indicating that the antenna device shall be checked and repaired at the next opportunity; but there is no urgency. To the contrary, large amounts of differences represent a dramatic deterioration. Thus, in these cases, not a warning but preferably an alarm is output to technicians in charge indicating that a quick repair of the antenna device 210 is required.

In the case of transmitting or transceiver antennas the performance of the antenna device is typically measured in the form of the voltage standard wave ratio VSWR parameter; consequently, the performance samples typically represent such a ratio averaged within the observation time of sample pi. However, in the case of receive-only-antennas other parameters, in particular received signal quality parameters like the “received signal strength indication” are more appropriate; in these cases the performance samples represent such indications.

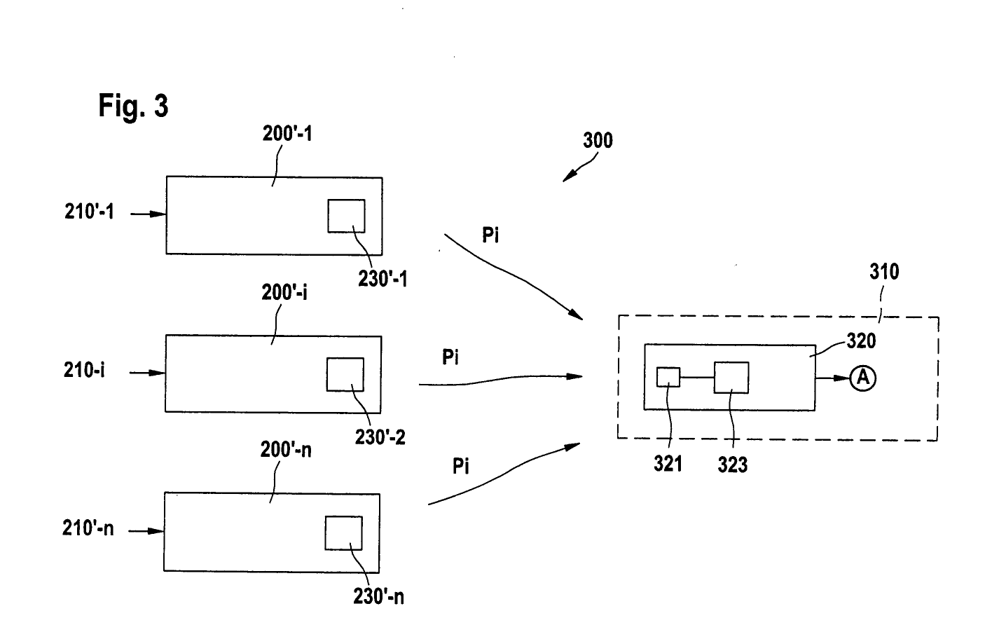

FIG. 3 shows another embodiment of the present invention. More specifically it illustrates the application of the present invention to a mobile radio system. Such a mobile radio system 300 comprises a plurality of radio base stations 200′-1 . . . 200′-n. These radio base stations 200′ are substantially built up the same as the radio base stations 200 described above by referring to FIG. 1.

However, the base stations 200′ differ from said previously described base stations 200 in that the detection of the deterioration, i.e. the comparison of the difference of the performance samples to the threshold values T_{R} is not carried out within said base stations 200′ but is carried out within an evaluation means 320 of said mobile radio system 300. Preferably, said evaluation unit 320 is part of a control station 310 typically comprised within said mobile radio system 300 for controlling the operation of said base stations 200′.

For carrying out the detecting operation the performance samples pᵢ measured within said radio base stations 200′ are preferably wirelessly transmitted from said base stations 200′-i with 1≦i≦n to said evaluation unit 320 within the mobile radio system 300; for achieving this the deterioration means 323 within the radio base stations described above by referring to FIG. 1 are replaced by transmitting means 230′-i with 1≦i≦n for transmitting said performance samples pᵢ. Further, within said evaluation unit 320 a receiving unit 321 must be provided for receiving said performance samples from said radio base stations. Additionally, the evaluation unit 320 comprises a detecting means 323 for detecting an eventual deterioration in the performance of the antenna devices 210′-i with 1≦i ≦n depending on the amount of the difference/variation of two compared performance samples pᵢ as described above. Said deterioration means 323 may be identical to the deterioration means 130 in FIG. 1.

The performance of receive-only-antennas may alternatively be checked by another monitoring method. This method is based on the fact that many receivers, especially base station receivers, use a technique called diversity reception. That means two receivers fed from two antenna systems are used in parallel to enhance the reception. The proposed alternative monitoring method takes advantage of this fact by comparing the measured quality parameters from the two antennas. Because it is very unlikely that both antennas will fail simultaneously, the difference between both parameters is used to generate warnings or alarms. If necessary, also a so-called training phase could be used to compensate an initial difference between the two antennas, e.g. if one antenna is shaded by some obstacles. In this case only the changing difference after the training phase is used for generating warnings or alarms.

The method according to the invention may be established in the form of a hardware or a software solution. In the case of a software solution a computer program comprising a sequence of instructions must be provided wherein said instructions are selected such that they are able to carry out the method steps according to the claimed and described method. The hardware solution or the software solution or a combination of both might be provided within the monitoring means, the radio base stations or the mobile radio system according to the invention. In the case of a software solution the computer program may together with other computer programs for controlling the monitoring means, the radio base stations or the mobile radio system stored on a storage medium. Said storage medium may be a disc, a compact disc or a flash memory, etc. The computer program stored on said storage medium represents a product which might be sold to a customer.

Further, in the case of a software solution it is possible that the computer program realizing the method according to the invention might—together with other programs—be transferred via a communications network without using said storage medium. This is another way to transfer the product “computer program” to a customer and to sell it to him. The communication network may be the internet.

According to another embodiment, a network monitoring device separated from the base stations or from the monitoring means is provided and measures the transmitting field strength Tₓ of said base stations and generates alarm signals depending on the amount of the difference between the performance measured during different measurements. However, an error detected by such a measurement might be caused by the antenna system of the monitoring means (100) or by a temporarily occurring obstacle.

1. Method for monitoring the performance of an antenna device comprising the steps of:
measuring from time to time the performance of the antenna device for achieving performance samples with 1≦i≦n,
watching the variation of said performance samples over the time; and
detecting a deterioration in the performance of the antenna device depending on the amount of said variation.

2. Method according to claim 1 wherein the step of watching the variation comprises the steps of:
storing at least two of said performance samples pᵢ; and
calculating the variation of two of said performance samples pᵢ by calculating the difference thereof.

3. Method of claim 2, wherein one of said two performance samples is an initial performance sample measured immediately after a proper installation of the antenna device or a previous performance sample measured before a last calculating step.

4. Method according to claim 3, wherein a first one of said performance samples is the previous performance sample and the second one of said performance samples is a new performance sample measured during a last measurement.

5. Method according to claim 4, wherein in the case that the difference between the previous and the new performance sample exceeds a predetermined first threshold value the deterioration in the performance of the antenna device is detected and a first type of alarm is generated.

6. Method according to claim 3, wherein a first one of said performance samples is the initial performance sample and a second one of said performance samples is a new performance sample measured during a last measurement.

7. Method according to claim 6, wherein in the case that the difference between the new and the initial performance sample exceeds a predetermined second threshold value the deterioration in the performance of the antenna device is detected and a second type of alarm is generated.

8. Method according to one of the preceding claims, wherein in the case that the antenna device is a radio receiver the performance samples represent a received signal quality parameter, preferably the “received signal strength indication” RSSI-parameter.

9. Method according to one of the preceding claims, wherein in the case that the antenna device is a radio transmitter the performance samples represent a transmitted signal quality parameter, preferably the “Voltage Wave Standing Ratio” VSWR-parameter.

10. Monitoring means for monitoring the performance of an antenna device, comprising
a measuring means for measuring from time to time the performance of the antenna device for achieving performance samples pᵢ with 1≦i≦n;
a watching means for watching the variation of said performance samples pᵢ over the time; and
a detecting means for detecting a deterioration in the performance of the antenna device depending on the amount of said variation.

11. Monitoring means according to claim 10, wherein the watching means comprises
a storage means for storing at least two of said performance samples; and
a calculating means for calculating the variation of two of said performance samples by calculating the difference thereof.

12. Monitoring means according to claim 10 or 11, wherein the detecting means comprises a comparator means for comparing said differences with a predetermined threshold value.

13. Radio base station having a transmitter and/or receiver each being connected to an antenna device and having a monitoring means according to one of claims 9-11.

14. Mobile radio system comprising:
a plurality of radio base stations each having a transmitter and/or a receiver each of which being connected to an antenna device and each base station having a measuring means for measuring from time to time the performance of the antenna device for achieving performance samples pᵢ, a storage means for storing at least two of said performance samples; and
sample transmitting means for transmitting said performance samples or differences of two of said performance samples to a remote evaluation unit; and
at least one control station for controlling the operation of said base stations; said control station comprising an evaluation unit for receiving said performance samples pᵢ or differences thereof with the help of a receiving unit from the sample transmitting means of the base stations and for evaluating said performance samples or said differences thereof in order to detect a deterioration of the performance of the antenna devices of the base stations.

15. Mobile radio system according to claim 14, wherein the evaluation unit is embodied to calculate the difference between two received performance samples pᵢ if said difference has not already been calculated in the base station and to generate an alarm in the case that the difference between two performance samples exceeds a predetermined threshold value.
